(19) United States
(12) Patent Application Publication
(10) Pub. No.: US 2018/0354255 A1
(43) Pub. Date: Dec. 13, 2018

(54) ANILOX CLEANING BLANKET

(71) Applicant: SUSTAINABLE SOLUTIONS INTERNATIONAL LLC, Pensacola, FL (US)

(72) Inventors: Gerald W. Mounsey, Pensacola, FL (US); Eric Speas, Calhoun, GA (US); Gary A. Abramek, Woonsocket, RI (US); Perry L. Muse, Johnson City, TN (US)

(73) Assignee: SUSTAINABLE SOLUTIONS INTERNATIONAL LLC, Pensacola, FL (US)

(21) Appl. No.: 15/952,734

(22) Filed: Apr. 13, 2018

Related U.S. Application Data
(60) Provisional application No. 62/516,291, filed on Jun. 7, 2017.

(51) Int. Cl. B41F 35/04; B32B 5/02; B32B 5/18; B32B 7/12; B32B 37/12; B32B 38/00; B32B 37/24

(52) U.S. Cl. CPC B41F 35/04; B32B 5/02; B32B 5/18; B32B 7/12; B32B 2432/00; B32B 38/0008; B32B 37/24; B41P 2235/21; B32B 37/12

(57) ABSTRACT

An anilox cleaning blanket. The anilox cleaning blanket may be installed on a plate cylinder of a printing system to clean an anilox roll. The blanket is made of a substrate. An adhesive layer is disposed on an upper surface of the substrate. A plurality of microfibers having a positive charge are adhered to the substrate by the adhesive layer. The microfibers engage with and clean the surface of the anilox roll.

### CROSS-REFERENCE TO RELATED APPLICATION

This application claims the benefit of priority of U.S. provisional application No. 62/516,291, filed Jun. 7, 2017, the contents of which are herein incorporated by reference.

### BACKGROUND OF THE INVENTION

The present invention relates to cleaning anilox rolls and, more particularly, to an anilox cleaning blanket and a method of making thereof.

Anilox Rolls are used in several printing industries like offset printing, process printing, flexographic printing, corrugated printing and the like to provide a measured amount of ink to a printing plate. An anilox roll is a hard cylinder, usually constructed of a steel or an aluminum core which is coated by an industrial ceramic whose surface contains millions of very fine dimples, known as cells. Depending on the design of the printing press, the anilox roll is either semi-submerged in the ink fountain, or comes into contact with a so-called metering roller, which is semi-submerged in the ink fountain. The anilox roll then rotates to contact with the printing plate to receive the ink for transfer to the printed material.

A serious problem plaguing anilox rolls is the tendency of the cells of the roll to slowly fill and become plugged with dry ink. Anilox rollers that are used with water, solvent and oil based inks must be cleaned immediately after use or a problem known as plugging occurs, where minuscule amounts of ink dry in the cells. The presences of dry ink in the cells causes tiny, but unacceptable, pinholes in anything printed from the roll in the future. Accordingly, proper maintenance of anilox rolls requires regular cleaning to maintain print quality

By their nature, anilox rolls are difficult to clean. Anilox rolls are incorporated into large presses with large numbers of parts that must be present near the roll for operation. This limits access to the roll for the purposes of cleaning. Additionally, large anilox rolls may be only movable by crane, making it difficult to remove a roll for cleaning. Even for small rolls, extreme caution must be taken when handling these pieces of hardware. A single bump against a hard surface or sharp corner can destroy the delicate cell structure on the surface and render a roller completely useless. Accordingly, methods of cleaning anilox rolls in place are preferred.

One previous method of cleaning anilox rolls in place is the use of brushes. Using brushes on anilox rolls has risks; it is important not to use the wrong type of brush on a roll. Nicks and scratches cause by a brush may add up quickly, so fine brushes (never brass brushes) are used for cleaning the anilox roll. For anilox rolls with special coatings, manufacturers may recommend against using brushes altogether. Additionally, the bristle tips of a brush are generally larger than the cells of anilox rollers used in most flexo printing. Thus, the bristles do not get into the cells, and brushing only breaks the film of ink on top of the cell walls, potentially leaving ink deposited within the cells.

Previous approaches to cleaning anilox rolls faced serious drawbacks and tradeoffs. Common cleaning methods have included: baking soda blast, plastic bead blast, dry ice blast, ultrasonic (small rolls only) and chemicals. Each of these approaches has advantages and disadvantages. Common disadvantages include expensive or time-consuming cleaning, the need to remove the anilox roll from the press, and importantly, the need for downtime to perform the cleaning. Thus, there is a need for easy-to-use, down-time free (that is, it may be used during production), inexpensive, alternative way to clean wide web anilox rolls.

As can be seen, there is a need for an anilox cleaning blanket with micro fibers and a method of making thereof.

### SUMMARY OF THE INVENTION

In one aspect of the present invention, a method of making an anilox cleaning blanket comprising the steps of: providing a substrate comprising an upper surface; applying an adhesive layer to the upper surface of the substrate; charging a plurality of microfibers; and delivering the charged plurality of microfibers to the adhesive layer on the substrate.

In another aspect of the present invention, an anilox cleaning blanket comprises: a substrate comprising an upper surface; an adhesive layer disposed on the upper surface of the substrate; and a plurality of microfibers comprising a positive charge adhered to the substrate by the adhesive layer.

These and other features, aspects and advantages of the present invention will become better understood with reference to the following drawings, description and claims.

### BRIEF DESCRIPTION OF THE DRAWINGS

FIG. 1 is a schematic side elevation view of an embodiment of the present invention; and

FIG. 2 is an enlarged detail side elevation view shown partly in cross section of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes an anilox roll cleaning blanket composite. The anilox cleaning blanket of the present invention mounts on a plate cylinder with a fast lock system or adhesive. The cleaning blanket of the present invention is a hybrid composite, sustainable (soy based or conventional polyol urethane foam), efficient, ergonomic, reusable, renewable and can be incinerated.

The anilox roll cleaning blanket composite varies in size and can be as thin as about 0.045 inches up to as thick as about 0.350 inches.

Fibers are electrostatically charged and secured to a flexible backing material (substrate/scrim) with an adhesive. The fibers may be substantially parallel relative to one another due to the electrostatic charge. From this point the material is cast with proprietary urethane foam and a polyester film (or skin) is laid in and secured to the backside of the composite.

The composite blanket top surface material is compatible with various cleaning solvents and water. The foam layer is compressible, resilient and has a resistance to absorbing chemicals that contain high alkalinity levels as well as resistant to EG, ME, MPH, and SH. The foam layer does not compromise the anilox cell or gravure cell. The present invention may be sold in roll form or in sheet form.

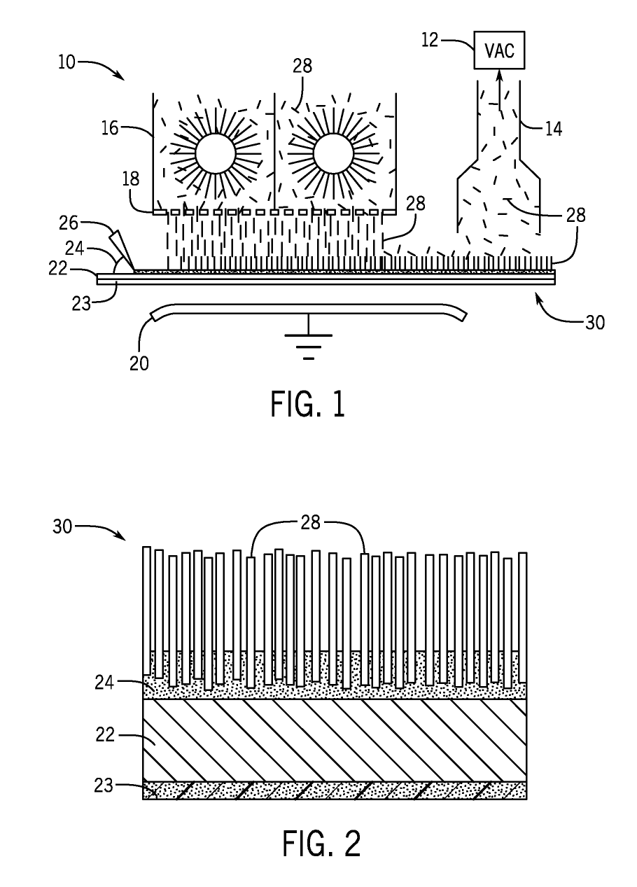

Referring to FIGS. 1 and 2, the present invention includes an anilox cleaning blanket 30. The anilox cleaning blanket 30 may be installed on a plate cylinder of a printing system to clean an anilox roll. The blanket 30 is made of a substrate 22. An adhesive layer 24 is disposed on an upper surface of the substrate 22. A plurality of microfibers 28 having a positive charge are adhered to the substrate 22 by the adhesive layer 24. The microfibers 28 engage with and clean the surface of the anilox roll.

Due to the charge, the plurality of microfibers 28 are perpendicular relative to the upper surface of the substrate at a point where the respective fiber is attached to the substrate. The plurality of microfibers 28 is a plurality of flocked fibers made of nylon, acrylic, polyester, suede, plastic, or a combination thereof.

In an embodiment, a fiber diameter of the micro-fibers 28 is approximately between about 5 to about 40 denier. Since one anilox roll cell is approximately 100 microns, the mechanical action of the relative rotation of the anilox roll and the plate cylinder or the micro-fiber cleaning roll may force the micro-fibers 28 into the cells to remove dried ink within. A micro-fiber height of the micro-fibers 28 may be chosen to trade-off stiffness, penetrating depth, and to maximize contact. In an embodiment, the micro-fibers 28 have a micro-fiber height at about 0.038 inches up to about and 0.35 inches.

The substrate 22 of the present invention may include a woven or non-woven fabric layer having an upper surface and a lower surface. The adhesive layer 24 may include a urethane, a water-based adhesive, a solvent based adhesive, a two part epoxy or other two part system, a hot melt, a glue, cement, mucilage, paste, or any substance that binds the microfibers 28 to the substrate 22.

The present invention may further include a foam layer 23 having an upper surface and a lower surface. The substrate 22 is applied or coupled to a lower surface of the substrate 22. The foam layer 23 may be an open-cell foam or a closed-cell foam. For example, the foam layer 23 may include quantum foam, polyurethane foam (foam rubber/elastomer), XPS foam, polystyrene, phenolic, or any other manufactured foam.

In certain embodiments, the anilox cleaning blanket 30 may be mounted to a mounting plate. The mounting plate may be made of polyvinyl chloride (PVC), polyethylene terephthalate (PET), or other dimensionally stable substrate. The mounting plate may include a surface area that is larger than the anilox cleaning blanket 30 to fully secure it. In an embodiment, the mounting plate is stiffer than the anilox cleaning blanket 30 and may include a curved shape. Accordingly, in some embodiments, when including the mounting plate, the anilox cleaning blanket 30 is naturally curved to cylinder shape by the curve of the mounting plate. The anilox cleaning blanket 30 used with the mounting plate may be used for bigger circumference 86″, 66″ and 50″ rolls.

The anilox cleaning blanket 30 may be installed on a plate cylinder of a printing system to clean an anilox roll. Leading and trailing edges of the anilox cleaning blanket 30 may be connected to the anilox roll by connectors, such as fast lock system (hooks), sleeves, adhesives and the like. Once the anilox cleaning blanket 30 is installed, the printing system may then be run, as if a print job was being run, to permit the anilox cleaning blanket 30 to come into contact with the anilox roll as they rotate. A detergent cleaner may be used in substitution for the ink to further assist the cleaning action. As the rolls turn, micro-fibers 28 on the surface of the anilox cleaning blanket 30 come into contact with the cells of the anilox roll and scour out dried ink.

The anilox cleaning blanket 30 may be made using the following process. The substrate 22 is provided. The adhesive layer 24 is applied to the upper surface of the substrate 22. The plurality of microfibers 28 are electrostatically charged and then delivered to the adhesive layer 24 on the substrate 22. Since the plurality of microfibers 28 are charged, the microfibers 28 are parallel relative to one another and perpendicular relative to the upper surface of the substrate 22 at a point where the respective fiber 28 is attached to the substrate 22.

A machine 10 is used to charge the microfibers 28 and then attach the microfibers 28 to the substrate 22. The machine 10 may include a hopper 16 for dispensing the microfibers 28 to the substrate 28. A conveyor 32 conveys the substrate 22 beneath the hopper 16 to receive the microfibers 28. The hopper 16 may further include a positive electrode grid 18 disposed above the conveyor 32. A grounded electrode 20 may be disposed beneath the conveyor 32. The microfibers 28 are positively charged while falling from the hopper 16 by the positive electrode grid 18 and the grounded electrode 20. The charged microfibers 28 then adhere to the adhesive layer 24 on the substrate 22. Excess microfibers 28 that do not adhere to the substrate 22 are then removed by a vacuum 12 and a suction column 14 disposed above the conveyor 32 and downstream of the hopper 16.

It should be understood, of course, that the foregoing relates to exemplary embodiments of the invention and that modifications may be made without departing from the spirit and scope of the invention as set forth in the following claims.

What is claimed is:

1. A method of making an anilox cleaning blanket comprising the steps of:
providing a substrate comprising an upper surface;
applying an adhesive layer to the upper surface of the substrate;
charging a plurality of microfibers; and
delivering the charged plurality of microfibers to the adhesive layer on the substrate.

2. The method of claim 1, further comprising the steps of:
providing a positive electrode grid disposed above the substrate; and
providing a grounded electrode disposed below the substrate, wherein
the plurality of microfibers are charged by passing through the positive electrode grid.

3. The method of claim 2, wherein the plurality of microfibers are delivered from a hopper disposed above the substrate.

4. The method of claim 3, wherein the positive electrode grid is coupled to the hopper.

5. The method of claim 3, further comprising the steps of:
providing a conveyor, wherein the substrate is conveyed on the conveyor to pass in between the positive electrode grid and the grounded electrode.

6. The method of claim 5, further comprising the step of vacuuming a plurality of excess microfibers from the substrate.

7. The method of claim 6, further comprising the step of providing a vacuum disposed above the conveyor, downstream of the hopper.

8. An anilox cleaning blanket comprising:
a substrate comprising an upper surface;
an adhesive layer disposed on the upper surface of the substrate; and
a plurality of microfibers comprising a positive charge adhered to the substrate by the adhesive layer.

9. The anilox cleaning blanket of claim 8, wherein the plurality of microfibers are perpendicular relative to the upper surface of the substrate at a point where the respective fiber is attached to the substrate.

10. The anilox cleaning blanket of claim 8, further comprising a foam layer comprising an upper surface coupled to a lower surface of the substrate.
